(19) United States
(12) Patent Application Publication
(10) Pub. No.: US 2026/0064458 A1
(43) Pub. Date: Mar. 5, 2026

(54) SYSTEMS AND METHODS FOR UPGRADING CONTROLLERS OF A BUILDING MANAGEMENT SYSTEM

(71) Applicant: Honeywell International Inc., Charlotte, NC (US)

(72) Inventors: Graham Lewry, East Sussex (GB); Shyamsundhar Madhusudhan, Chennai (IN); Weilin Zhang, Beijing (CN); Yi Sun, Beijing (CN)

(21) Appl. No.: 19/299,995

(22) Filed: Aug. 14, 2025

(30) Foreign Application Priority Data
Aug. 28, 2024 (IN) 202411064938

(51) Int. Cl. G06F 9/48; G06F 9/445; G06F 9/451

(52) U.S. Cl. CPC G06F 9/4856; G06F 9/44526; G06F 9/453; G06F 2209/482

(57) ABSTRACT

A source controller running a control application that includes a plurality of control application components may be migrated to a target controller of a BMS system. The source controller may be selected and the plurality of control application components running on the source controller may be detected. A selection of the target controller and one or more of the control application components may be selected to migrate to the selected target controller. An application component migration strategy is assembled for each of the selected control application components that identifies a migration plugin from a migration plugin library for migrating the respective control application component from the selected source controller to the selected target controller. Each of the selected control application components are migrated from the selected source controller to the selected target controller using the respective migration plugin identified in the respective application component migration strategy.

### RELATED APPLICATIONS

This application claims the benefit of Indian Provisional Application No. 202411064938, filed Aug. 28, 2024, which application is incorporated by reference herein.

### TECHNICAL FIELD

The present disclosure relates generally to building management systems and more particularly to migrating a source controller to a target controller in a building management system.

### BACKGROUND

Building Management Systems are systems that control and/or monitor one or more functions of a building or other facility. Building Management Systems may include, for example, an HVAC system, a security system, a video management system, an access control system, a fire system, and/or any other suitable Building Control System. Building Management Systems can include a large number of controllers. For example, an HVAC system may include a number of different controllers that operate various components within the HVAC system of various different zones. As another example, an access control system may include a number of different controllers. Over time, it may be desirable to upgrade existing controllers. Upgrading controllers can be a time consuming, tedious and error prone process. While controller upgrade tools exist, they are typically purpose-built, i.e., used to upgrade a particular component (e.g. particular component of a control application) of a particular type and particular model of a controller. What would be desirable are methods and systems for providing an upgrade tool framework for upgrading any of a variety of different types and models of controllers.

### SUMMARY

The present disclosure relates generally to building management systems and more particularly to upgrading controllers of a building management system. An example may be found in a method for migrating a source controller to a target controller of a BMS system, wherein the source controller runs a control application that includes a plurality of control application components. The illustrative method includes receiving a selection of the source controller and automatically detecting the plurality of control application components running on the source controller. A selection of the target controller is received. In some cases, the target controller may be the source controller. In other cases, the target controller may be a replacement controller. A selection of one or more of the control application components running on the source controller to migrate to the selected target controller is received. An application component migration strategy is automatically assembled for each of the selected control application components running on the selected source controller, wherein the respective application component migration strategy identifies a migration plugin from a plurality of predefined migration plugins of a migration plugin library for migrating the respective control application component from the selected source controller to the selected target controller. Each of the selected control application components running on the selected source controller are migrated from the selected source controller to the selected target controller using the respective migration plugin identified in the respective application component migration strategy.

Another example may be found in a migration tool for migrating a source controller to a target controller of a Building Management System (BMS), wherein the source controller runs a control application that includes a plurality of control application components. The migration tool includes an input/output for communicating with the source controller and the target controller, a user interface, and a controller that is operatively coupled to the input/output and the user interface. The controller of the migration tool is configured to receive a selection via the user interface of the source controller and to receive via the input/output an identification of the plurality of control application components running on the source controller. The controller of the migration tool is configured to receive via the user interface a selection of the target controller and a selection of one or more of the control application components running on the source controller to migrate to the selected target controller. In some cases, the selected target controller may be the source controller. In other cases, the selected target controller may be a replacement controller. The controller of the migration tool is configured to assemble an application component migration strategy for each of the selected control application components running on the selected source controller, wherein the respective application component migration strategy identifies a migration plugin from a plurality of predefined migration plugins of a migration plugin library for migrating the respective control application component from the selected source controller to the selected target controller. The controller of the migration tool is configured to migrate each of the selected control application components running on the selected source controller from the selected source controller to the selected target controller using the respective migration plugin identified in the respective application component migration strategy.

Another example may be found in a non-transitory computer readable medium storing instructions. When the instructions are executed by one or more processors, the one or more processors are caused to receive a selection via a user interface of a source controller of a Building Management System (BMS). The one or more processors are caused to receive an identification of one or more control application components running on the source controller. The one or more processors are caused to receive a selection of a target controller and to receive a selection of one or more of the control application components running on the source controller to migrate to the selected target controller. The one or more processors are caused to assemble an application component migration strategy for each of the selected control application components running on the selected source controller, wherein the respective application component migration strategy identifies a migration process for migrating the respective control application component from the selected source controller to the selected target controller. The one or more processors are caused to migrate each of the selected control application components running on the selected source controller from the selected source controller to the selected target controller in compliance with the respective application component migration strategy.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system including an illustrative migration tool and plugin library;

FIG. 2 is a schematic block diagram showing an illustrative system;

FIG. 3 is a schematic block diagram showing an illustrative workflow;

FIGS. 4A, 4B and 4C are flow diagrams that together show an illustrative method for migrating a source controller to a target controller;

FIGS. 5A and 5B are flow diagrams that together show an illustrative series of steps that may be carried out by one or more processors executing stored instructions;

FIG. 6 is a screen capture showing a step in carrying out an HMI migration;

FIG. 7 is a schematic block diagram showing a step of carrying out an HMI migration;

FIG. 8 is a screen capture showing a step of carrying out an HMI migration;

FIG. 9 is a screen capture showing a step of carrying out an HMI migration;

FIG. 10 is a screen capture showing a step of carrying out an HMI migration;

FIG. 11A is a screen capture showing a step of carrying out an HMI migration;

FIG. 11B is a screen capture showing a step of carrying out an HMI migration;

FIG. 12 is a screen capture showing a step of carrying out an HMI migration;

FIG. 13 is a schematic block diagram summarizing an HMI migration; and

FIG. 14 is a screen capture showing a step of carrying out IO terminal mapping for a migration.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/of” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

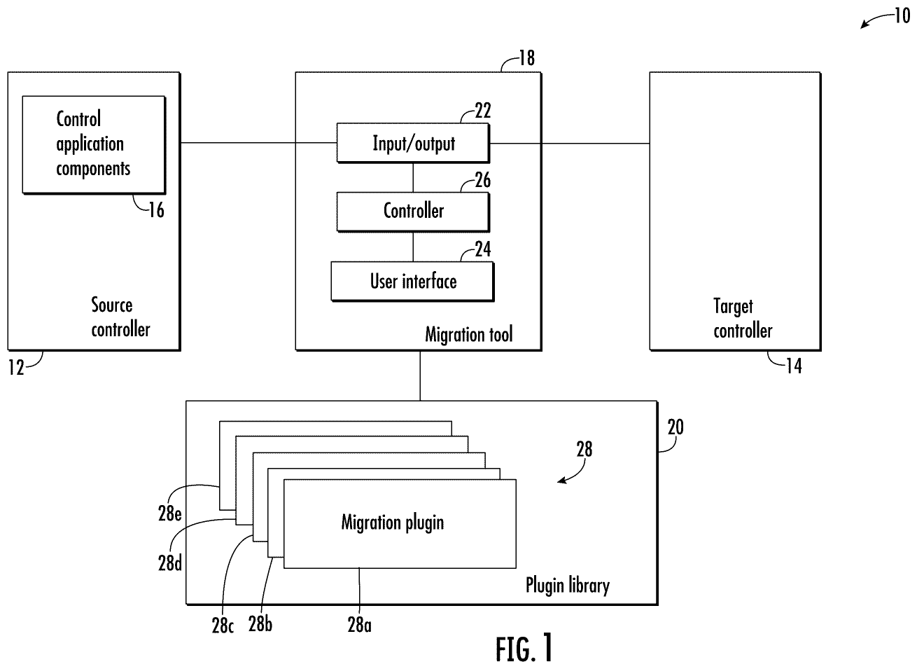

FIG. 1 is a schematic block diagram of an illustrative system 10. The system 10 may be considered as being part of a Building Management System (BMS), for example. The system 10 may be considered as including a source controller 12 and a target controller 14 of a BMS. While a single source controller 12 is shown, it will be appreciated that a BMS may include a large number of source controllers. As shown, the target controller 14 is distinct from the source controller 12. In some cases, the target controller 14 may be a newer version of the source controller 12. In some cases, the target controller 14 may be the same model as the source controller 12, particularly if the source controller 12 is being replaced due to one or more flaws within the source controller 12 rather than replacing the source controller 12 with the target controller 14 because the target controller 14 has additional features or capabilities not included in the source controller 12. In some cases, a source controller 12 and the target controller 14 may be the same controller, particularly when only software components within the controller are being updated.

In the example shown, the source controller 12 includes control application components 16. The control application components 16 may include various software programs, for example. In some cases, the control application components 16 may be configured by one or more configuration settings that can be updated or migrated from the source controller 12 to the target controller 14. The configuration settings may include, for example, equipment settings, setpoint settings, network settings, Bluetooth settings, connected device specifics, IO terminal details, device information, point data, and/or any other suitable configuration information. In some cases, the control application components 16 may collect and store respective support data and/or log information that can also be migrated from the source controller 12 to the target controller 14. As an example, the support data and/or log information may include current and/or historical data. As another example, the support data and/or log information may include current and/or historical alarm data and/or sensor data. In some cases, the control application components 16 on the source controller 12 may be a first version which will be updated to a second updated version on the target controller 14. The control application components 16 may include control points that are migrated from the source controller 12 to the target controller 14. These are just examples.

A migration tool 18 may be used, in conjunction with a plugin library 20, to migrate control application components 16 of the source controller 12 to the target controller 14. The illustrative migration tool 18 includes an input/output 22 for communicating with the source controller 12 and the target controller 14 and a user interface 24. A controller 26 is operatively coupled to the input/output 22 and to the user interface 24. The plugin library 20 includes a variety of migration plugins 28, individually labeled as 28a, 28b, 28c, 28d and 28e. The plugin library 20 may include any number of migration plugins 28, and may include considerably more than five migration plugins 28, for example. The controller 26 is configured to receive a selection via the user interface 24 of the source controller. A user may tell the controller 26 which of the various source controllers they wish to upgrade and/or replace, thus selecting the particular source controller 12. The controller 26 receives via the input/output 22 an identification of the control application components 16 that are running on the source controller 12. The controller 26 receives via the user interface 24 a selection of the target controller 14 as well as a selection of which of the control application components 16 that are running on the source controller 12 should be updated and/or migrated to the target controller 14.

The controller 26 is configured to assemble an application component migration strategy for each of the selected control application components 16 running on the selected source controller 12, wherein the respective application component migration strategy identifies a migration plugin 28 from the plurality of predefined migration plugins 28 of the migration plugin library 20 for migrating the respective control application component 16 from the selected source controller 12 to the selected target controller 14. In some cases, the migration plugin library 20 may include predefined migration plugins 28 that are programmed for each combination of source controller, target controller and control application component. The controller 26 is configured to migrate each of the selected control application components 16 running on the selected source controller 12 from the selected source controller 12 to the selected target controller 14 using the respective migration plugin 28 identified in the respective application component migration strategy. In some cases, the controller 26 may be configured to migrate each of the selected control application components 16 running on the selected source controller 12 from the selected source controller 12 to the selected target controller 14 using the respective migration plugin 28 identified in the respective application component migration strategy without taking offline, stopping, rebooting or otherwise interrupting the operation of the Building Management System (BMS).

In some cases, one or more of the plurality of control application components 16 may be configured by one or more configuration settings, and wherein the controller 26 of the migration tool 18 may be configured to collect configuration settings associated with each of the control application components 16 running on the source controller 12 via the input/output 22. Migrating each of the selected control application components from the selected source controller 12 to the selected target controller 14 using the respective migration plugin 28 identified in the respective application component migration strategy may include migrating the configuration settings associated with the respective control application component 16.

In some cases, one or more of the plurality of control application components 16 may collect and store respective support data and/or log information, and the controller 26 of the migration tool 18 may be configured to collect support data and/or log information associated with each of the control application components 16 running on the source controller 12. Migrating each of the selected control application components 16 from the selected source controller 12 to the selected target controller 14 using the respective migration plugin 28 identified in the respective application component migration strategy may include migrating the support data and/or log information associated with the respective control application component 16.

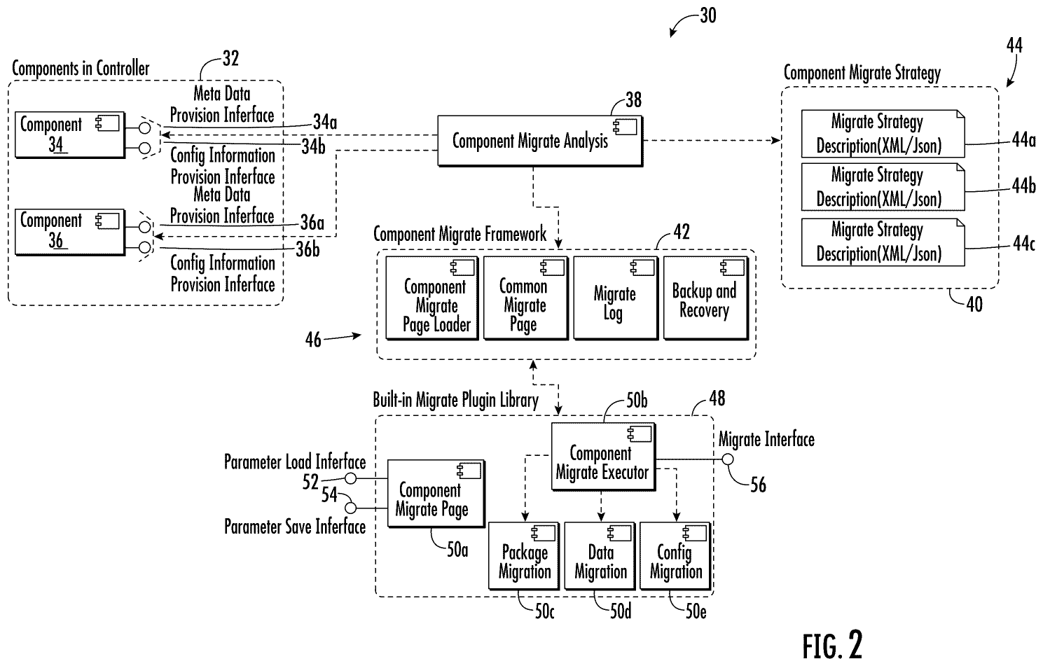

FIG. 2 is a schematic block diagram of an illustrative system 30. In some cases, the system 30 may be considered as being an example of the system 10. In some cases, the system 30 may be considered as being incorporated within the system 10. The system 30 includes a source controller 32 that has a control application component 34 and a control application component 36. Each of the control application component 34 and the control application component 36 of the source controller 32 may represent examples of the control application components 16 of FIG. 1. As can be seen, each of the control application components 34 and 36 include a metadata provision interface 34a and 36a, respectively, and a config information provision interface 34b and 36b, respectively. These are preprogrammed interfaces that were previously installed on the source controller 32. The control application components 34 and 36 communicate via the metadata provision interfaces 34a and 36a and the config information provisional interfaces 34b and 36b with a component migrate analysis block 38 of a migration tool, such as migration tool 18 of FIG. 1. The component migrate analysis block 38 outputs a component migrate strategy 40 and a common migrate framework 42 to support the migration.

The component migrate strategy may include a number of migrate strategy descriptions 44, individually labeled as 44a, 44b and 44c. The common migrate framework 42 may include a number of elements 46 including, for example, a component migrate page loader 46a, a common migrate page 46b, a migrate log 46c and a backup and recovery 46d, some or all of which are tailored to the particular migration at hand. Other elements 46 may also be included. The common migrate framework 42 may communicate with a migrate plugin library 48 including a number of components 50. The migrate plugin library 48 may include a component migrate page 50a, a component migrate executor 50b, a package migration plugin 50c, a data migration plugin 50d and a config migration plugin 50e. In some cases, the migrate plugin library 48 may include a parameter load interface 52, a parameter save interface 54 and a migrate interface 56.

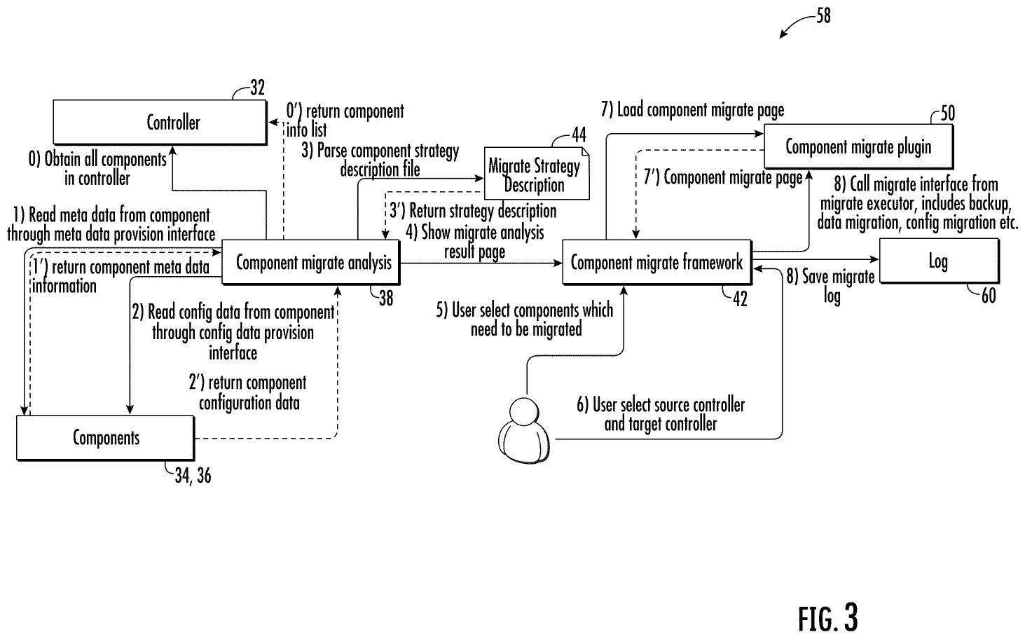

FIG. 3 provides a workflow 58 showing how the illustrative system 30 functions. At step zero (0), the component migrate analysis block 38 solicits and receives a listing of all of the components within the source controller 32. At step one (1), the component migrate analysis block 38 solicits and receives the metadata via the metadata provision interfaces 34a and 36a for each of the listed components within the source controller 32. At step two (2), the component migrate analysis block 38 solicits and receives the config data via the config information provision interfaces 34b and 36b for each of the listed components within the controller. At step three (3), a master component strategy description file is parsed to extract component strategy elements that are relevant to the migration of the listed components within the source controller 32, and assembly and provide a migration strategy description to the component migrate analysis block 38. At step four (4), a migrate analysis page that is based on the migration strategy description is generated and provided by the component migrate analysis block 38 to a common migrate framework 42. At step five (5), the user selects which components are to be migrated. At step six (6), the user selects the source controller and the target controller. At step seven (7), a component migrate page is loaded and returned to the common migrate framework 42. At step eight (8), a migrate interface is called and migration occurs. At step nine (9), a migrate log 60 is saved.

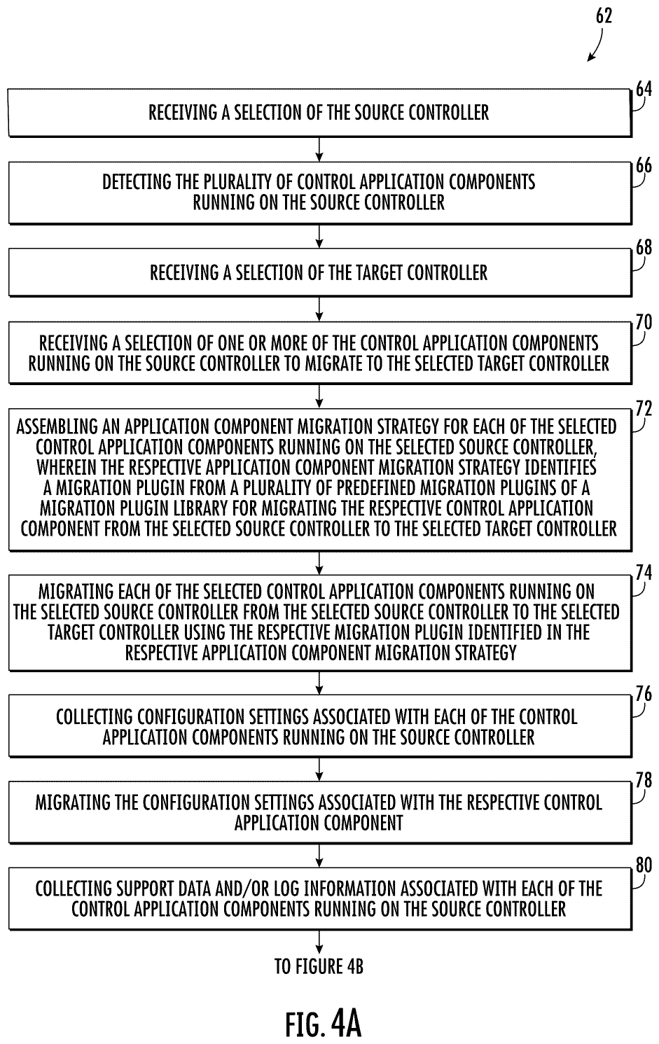

FIGS. 4A, 4B and 4C are flow diagrams that together show an illustrative method 62 for migrating a source controller (such as the source controller 12) to a target controller (such as the target controller 14) of a BMS system, wherein the source controller runs a control application that includes a plurality of control application components (such as the control application components 16). The method 62 includes receiving a selection of the source controller, as indicated at block 64. The plurality of control application components running on the source controller are detected, as indicated at block 66. A selection of the target controller is received, as indicated at block 68. A selection of one or more of the control application components running on the source controller to migrate to the selected target controller is received, as indicated at block 70. An application component migration strategy is automatically assembled for each of the selected control application components running on the selected source controller, wherein the respective application component migration strategy identifies a migration plugin from a plurality of predefined migration plugins (such as the migration plugins 28) of a migration plugin library (such as the plugin library 20) for migrating the respective control application component from the selected source controller to the selected target controller, as indicated at block 72.

In some cases, assembling the application component migration strategy for each of the selected control application components running on the selected source controller may include extracting the application component migration strategy for each of the selected control application components from a master component migration strategy source or file. In some cases, extracting the application component migration strategy may include parsing the master component migration strategy source to identify and extract one or more parts of the master component migration strategy source based at least in part on one or more of the selected control application component, the selected source controller, and/or the selected target controller. In some cases, the selected control application component running on the selected source controller has a first version, and the selected control application component to be migrated to the selected target controller has a second version that is different from the first version. Parsing the master component migration strategy source to include one or more parts of the master component migration strategy source may be based at least in part on the first version of the selected control application component running on the selected source controller and the second version of the selected control application component to be migrated to the selected target controller. Each of the selected control application components running on the selected source controller are migrated from the selected source controller to the selected target controller using a respective migration plugin identified in the respective application component migration strategy, as indicated at block 74.

In some cases, one or more of the plurality of control application components may be configured by one or more configuration settings and the method 62 may include collecting configuration settings associated with each of the control application components running on the source controller, as indicated at block 76. The configuration settings may be collected via the configuration information provision interface 34b associated with the respective control application components. Migrating each of the selected control application components from the selected source controller to the selected target controller using the respective migration plugin identified in the respective application component migration strategy may include migrating the configuration settings that is associated with the respective control application component, as indicated at block 78.

In some cases, one or more of the plurality of control application components may collect and share respective support data and/or log information, and the method 62 may include collecting support data and/or log information associated with each of the control application components running on the source controller, as indicated at block 80. In some cases, the support data and/or log information may include current and/or historical data. In some cases, the support data and/or log information may include alarm data and/or sensor data, for example. The support data and/or log information may be collected via the configuration information provision interface 34b that is associated with the respective control application components. Migrating each of the selected control application components from the selected source controller to the selected target controller using the respective migration plugin identified in the respective application component migration strategy may include migrating the support data and/or log information associated with the respective control application component, as indicated at block 82 on FIG. 4B.

In some cases, each of the selected one or more of the control application components running on the source controller may include one or more control points, and the method 62 may include receiving a selection of one or more additional points to add to a selected one of the control application components that are to be migrated to the selected target controller, as indicated at block 84. In some cases, the selected target controller or the upgraded control application component may allow use of additional control points. The selected one or more additional points may be added to the selected control application component during the migration of the selected control application component from the selected source controller to the selected target controller, as indicated at block 86.

In some cases, each of the selected one or more of the control application components running on the source controller may include one or more control points that are mapped to a corresponding terminal of the source controller, and the method 62 may include receiving a mapping of one or more of the control points of a selected one of the control application components to a selected terminal of the target controller, as indicated at block 88. The mapping may be used during the migration of the selected control application component from the selected source controller to the selected target controller.

In some cases, the application component migration strategy for each of the selected control application components running on the selected source controller may include a human readable description of one or more steps of the migration strategy of the respective control application component from the selected source controller to the selected target controller. In some cases, the migration plugin identified by the respective application component migration strategy may automatically perform one or more of the steps of the migration of the respective control application component from the selected source controller to the selected target controller. In some cases, one or more of the steps of the migration of the respective control application component from the selected source controller to the selected target controller may need to be performed manually, such as rebooting the target controller during the migration.

In some cases, one or more steps of the migration of the respective control application component may be automatically carried out by the migration plugin, as indicated at block 90. The one or more steps may include migrating one or more configuration settings from the selected source controller to the selected target controller, as indicated at block 90a. The one or more steps may include migrating support data and/or log information from the selected source controller to the selected target controller, as indicated at block 90b. The one or more steps may include migrating schedule information from the selected source controller to the selected target controller, as indicated at block 90c. The one or more steps may include migrating one or more Fast Access List (FAL) entries from the selected source controller to the selected target controller, as indicated at block 90d. These are just examples.

In some cases, and continuing on FIG. 4C, the method 62 may include determining that one or more components running on the source controller that have an upgrade available, as indicated at block 92. One or more component upgrade suggestions may be provided to a user via a user interface, as indicated at block 94. The one or more component upgrade suggestions may be provided to the user when the user is selecting the components to upgrade.

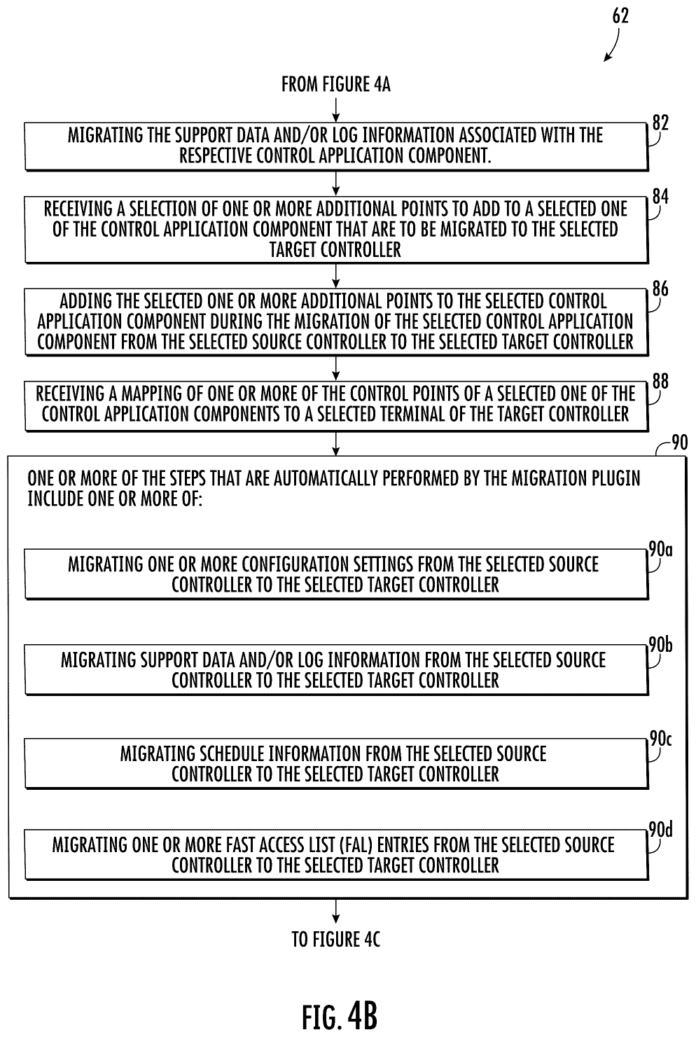

FIGS. 5A and 5B are flow diagrams that together show an illustrative series of steps 96 that may be carried out by one or more processors that are executing instructions that are stored on a non-transitory computer-readable storage medium. The one or more processors may be part of the controller 26, for example. The one or more processors may be caused to receive a selection via a user interface of a source controller of a Building Management System (BMS), as indicated at block 98. The one or more processors may be caused to receive an identification of one or more control application components running on the selected source controller, as indicated at block 100. The one or more processors may be caused to receive a selection of a target controller, as indicated at block 102. The one or more processors may be caused to receive a selection of one or more of the control application components running on the selected source controller to migrate to the selected target controller, as indicated at block 104. The one or more processors may be caused to assemble an application component migration strategy for each of the selected control application components running on the selected source controller, wherein the respective application component migration strategy identifies a migration process for migrating the respective control application component from the selected source controller to the selected target controller, as indicated at block 106. The one or more processors may be caused to migrate each of the selected control application components running on the selected source controller from the selected source controller to the selected target controller in compliance with the respective application component migration strategy, as indicated at block 108.

In some cases, the one or more processors may be caused to automatically collect configuration settings associated with each of the control application components running on the source controller, as indicated at block 110. The one or more processors may be caused to migrate the configuration settings associated with the respective control application component from the selected source controller to the selected target controller, as indicated at block 112 on FIG. 5B. The one or more processors may be caused to automatically collect support data and/or log information associated with each of the control application components running on the source controller, as indicated at block 114. The one or more processors may be caused to migrate the support data and/or log information associated with the respective control application component from the selected source controller to the selected target controller, as indicated at block 116.

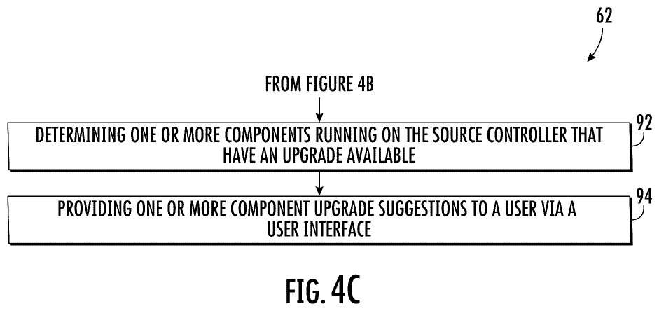

FIGS. 6 through 13 provide an example of an Human Machine Interface (HMI) Network control application component migration from version 1.0 to version 2.0. In this example, the source controller and the target controller may correspond to the same physical device, but this is not required. In FIG. 6, a screen 118 is shown that shows a listing of all of the control application components of a source controller that may be upgraded, and allows a user to select which of the control application components are to be upgraded. The screen 118 may be displayed on the user interface 24 of the migration tool 18, for example. As shown, there is an HMI (Human Machine Interface) Network control application component 120, a PanelBus Network control application component 122 and an OnboardIO Network control application component 124. The HMI Network control application component 120 has been selected, as indicated by a checkmark 126. A Next button 128 and a Cancel button 130 allow the user to navigate through multiple screens, as desired. In this example, the screen or page 118 is tailored to include the control application components running on the particular source controller.

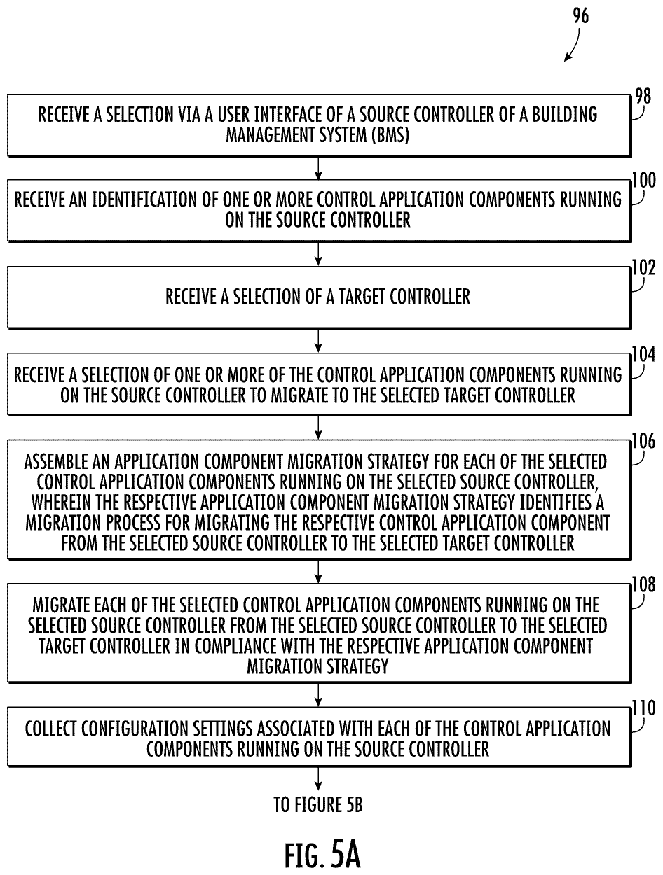

FIG. 7 provides an illustrative block diagram 132 showing that an HMI Network control application component block 134 provides metadata 136 via a metadata interface 138 (similar to the metadata provision interfaces 34a and 36a). The HMI Network control application component block 134 provides config data via a config data interface 140 (similar to the config data provision interfaces 34b and 36b.

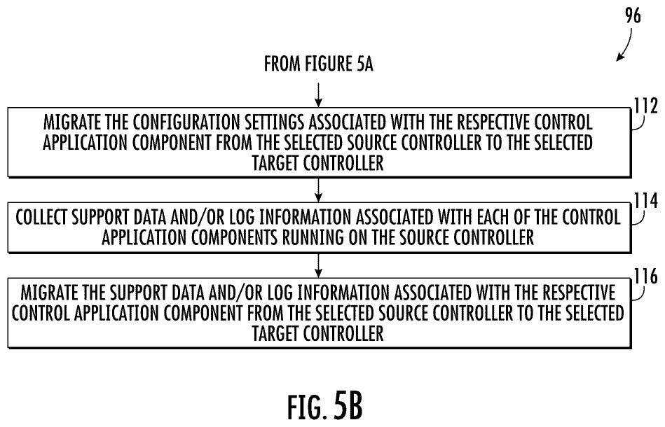

FIG. 8 provides a screen or page 144 that may be displayed in response to the user selecting the Next button 128 in FIG. 6. The screen 144 may be displayed on the user interface 24 of the migration tool 18, for example. The screen 144 includes information 146 that describes the HMI network control application component, including identifying current and target versions, upgrade features and upgrade notes. The screen 144 also includes a Previous button 148, a Next button 150 and a Cancel button 152 that may be used by the user to navigate through multiple screens, as desired. After confirming the information 146, the user may select the Next button 150, and a migrate strategy is automatically generated.

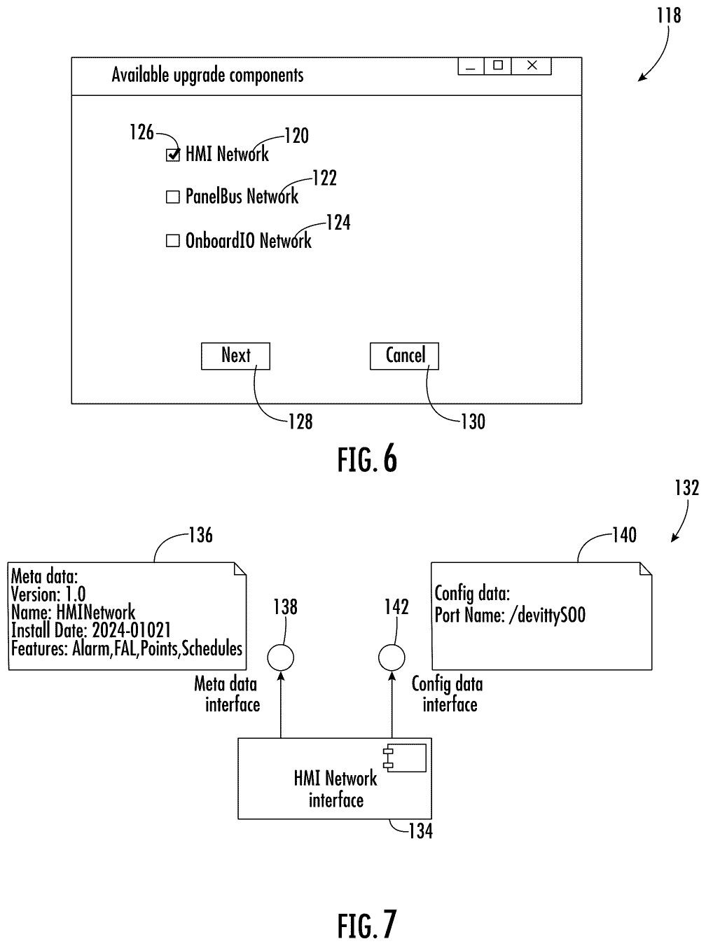

FIG. 9 provides a screen 154 that includes a migrate strategy description that informs the user of the automatically generated migration strategy. The screen 154 may be displayed on the user interface 24 of the migration tool 18, for example. In some cases, the automatically generated migration strategy may include one or more steps that to be performed manually by the user (e.g. restart the target controller when instructed).

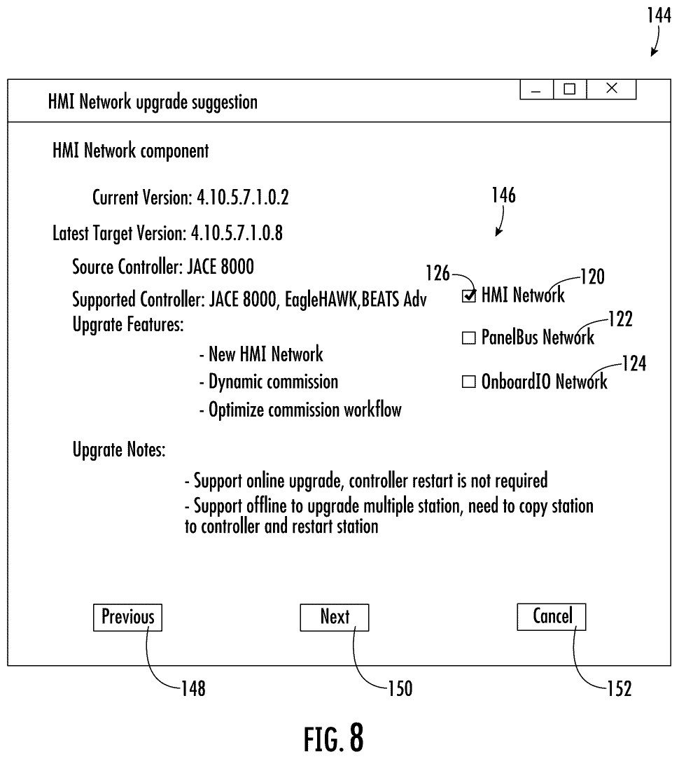

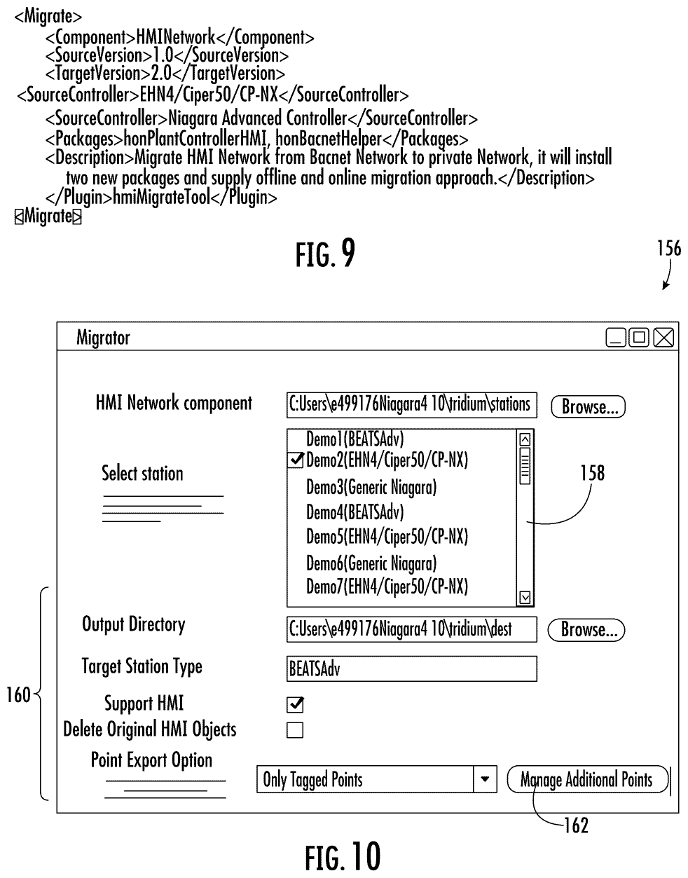

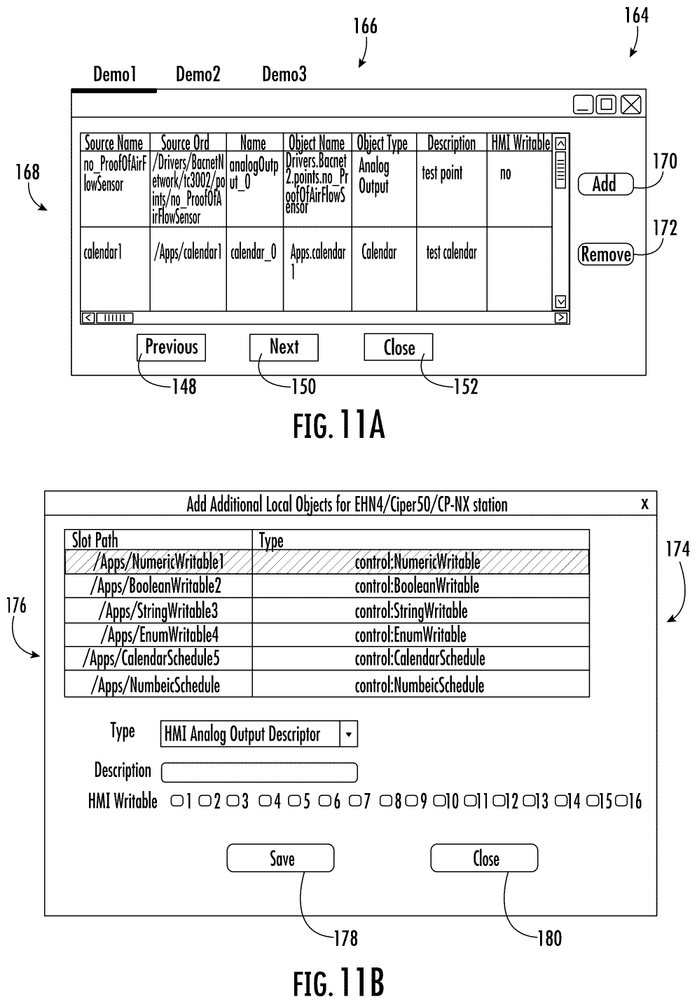

FIG. 10 provides a screen 156 that includes migration information. The screen 156 may be displayed on the user interface 24 of the migration tool 18, for example. The screen 156 includes a listing 158 of controllers. The user is able to select one controller or multiple controllers from the listing 158 by clicking on the desired controllers to upgrade. A section 160 includes a listing of configuration items. Some of the configuration items may be enabled or disabled, depending on which controllers were selected. The screen 156 includes a Manage Additional Points button 162. Selecting the Manage Additional Points button 162 allows for additional points to be managed, and will cause the migration tool 18 to display on the user interface 24 a screen 164, such as shown in FIG. 11A.

The screen 164 includes a listing of controllers 166 and a listing 168 of available points for the selected controller. In some cases, the selected target controller or the upgraded control application component may allow use of additional control points. As shown, a controller named Demo1 has been selected. The screen 164 includes an Add button 170 that may be used to add additional points and a Remove button 172 that may be used to remove one or more points. Clicking the Add button 170 will cause the migration tool 18 to display a screen 174 as shown in FIG. 11B. The screen 174 includes a listing 176 of points that may be added. A Save button 178 allows the user to save the added points, and a Close button 180 allows the user to revert to a previous screen.

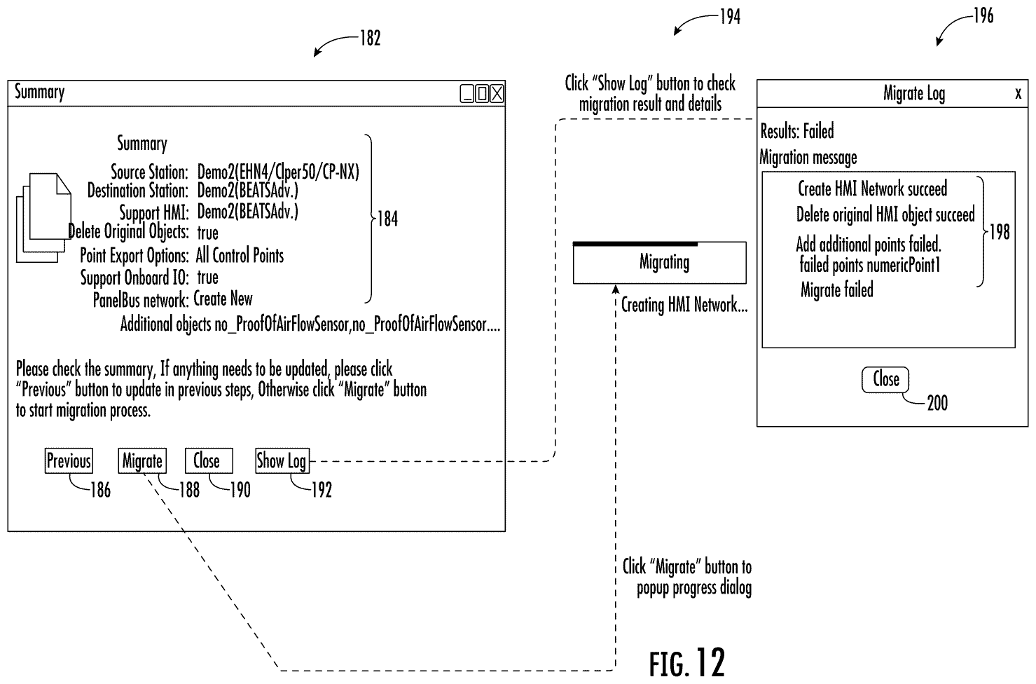

FIG. 12 provides a screen 182 on the left hand side of FIG. 12 that provides a summary 184 for the proposed migration. The user is able to confirm the details within the summary 184 before initiating the actual migration (e.g. before the actual copying of files, settings and/or other information to the target controller). The screen 184 includes a Previous button 186, a Migrate button 188, a Close button 190 and a Show Log button 192. Selecting the Migrate button 188 causes a screen 194 to be displayed, as shown in the middle of FIG. 12. The screen 194 provides a progress bar for the migration. Alternatively, selecting the Show Log button 192 causes a screen 196 to be displayed, as shown on the right hand side of FIG. 12. The screen 196 includes a migration message 198 informing the user of the results of the attempted migration. In this particular case, the migration failed. The screen 196 includes a Close button 200 that allows the user to return to a previous screen.

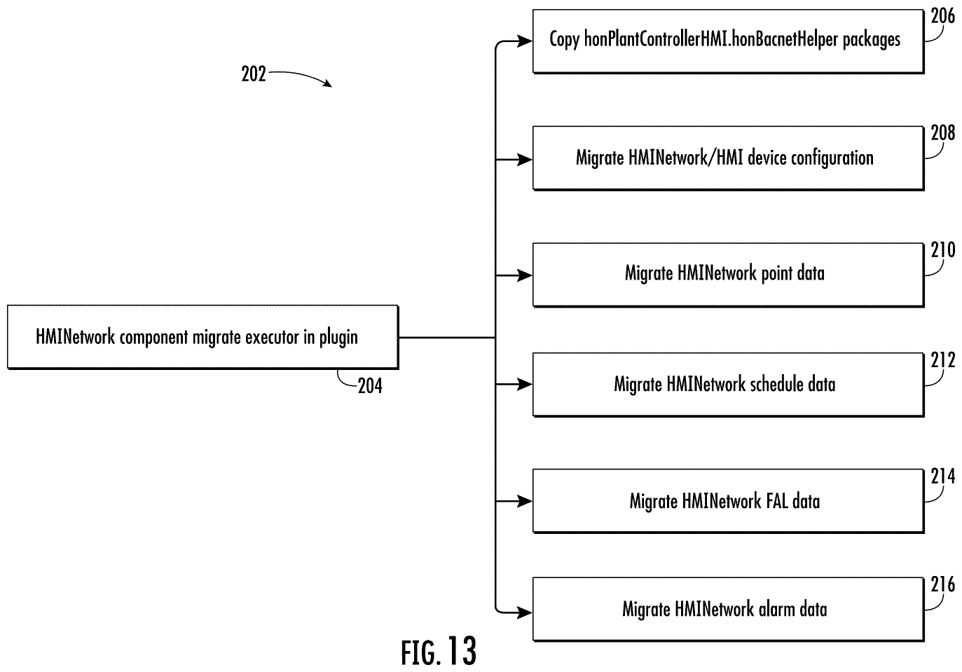

FIG. 13 is a block diagram showing an illustrative summation 202 of an HMI control application component migration. The summation 202 includes an HMI Network control application component migrate executor in plugin 204 that carries out and controls the migration. In some cases, the common migrate framework 42 may call the migrate interface provided by the HMI MigrateTool plugin. This includes copying packages, as indicated at block 206, migrating the device configuration as indicated at block 208, migrating point data as indicated at block 210, migrating schedule data as indicated at block 212, migrating FAL data as indicated at block 214 and migrating alarm data as indicated at block 216. In some cases, the blocks 210, 212, 214 and 216 may be involved in migrating from an existing BACnet network to an HMI network.

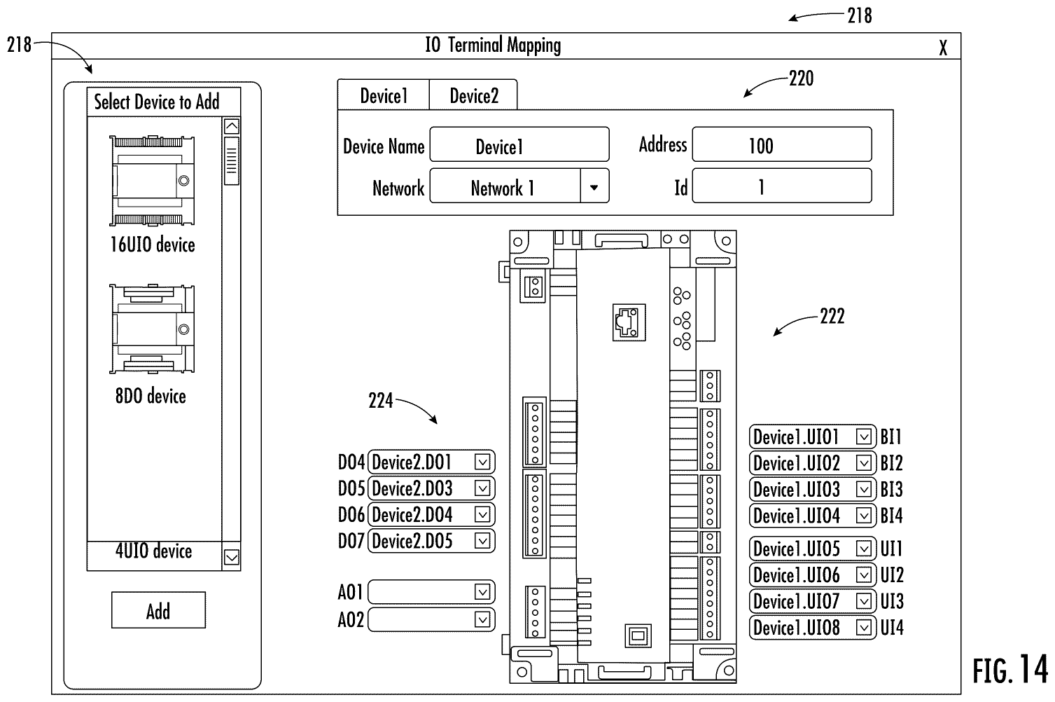

FIG. 14 provides an example of IO terminal mapping screen or page for mapping terminals between a first device and a second replacement device. FIG. 14 includes a listing 218 of available devices to add. A section 220 allows the user to select between displaying a device1 and a device2, with perhaps device1 representing the original device and device2 representing the replacement device. As shown, device1 is selected, so FIG. 14 includes a graphical representation 222 of device1. The graphical representation includes a listing 224 of available terminals. The user is able to change the control point that assigned to a particular terminal of the device via a drop down box. The drop down box displays a listing of control points that are compatible with the particular terminal. For example, for an analog input terminal, the corresponding drop down box may only allow selection of control points that are compatible with the analog input terminal type.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for migrating a source controller to a target controller of a BMS system, wherein the source controller runs a control application that includes a plurality of control application components, the method comprising:
receiving a selection of the source controller;
detecting the plurality of control application components running on the source controller;
receiving a selection of the target controller;
receiving a selection of one or more of the control application components running on the source controller to migrate to the selected target controller;
assembling an application component migration strategy for each of the selected control application components running on the selected source controller, wherein the respective application component migration strategy identifies a migration plugin from a plurality of predefined migration plugins of a migration plugin library for migrating the respective control application component from the selected source controller to the selected target controller; and
migrating each of the selected control application components running on the selected source controller from the selected source controller to the selected target controller using the respective migration plugin identified in the respective application component migration strategy.

2. The method of claim 1, wherein one or more of the plurality of control application components is configured by one or more configuration settings, the method comprising:
collecting configuration settings associated with each of the control application components running on the source controller; and
wherein migrating each of the selected control application components from the selected source controller to the selected target controller using the respective migration plugin identified in the respective application component migration strategy includes migrating the configuration settings associated with the respective control application component.

3. The method of claim 1, wherein one or more of the plurality of control application components collects and stores respective support data and/or log information, the method comprising:
collecting support data and/or log information associated with each of the control application components running on the source controller; and
wherein migrating each of the selected control application components from the selected source controller to the selected target controller using the respective migration plugin identified in the respective application component migration strategy includes migrating the support data and/or log information associated with the respective control application component.

4. The method of claim 3, wherein the support data and/or log information includes one or more of current and/or historical data.

5. The method of claim 4, wherein the support data and/or log information includes one or more of alarm data and sensor data.

6. The method of claim 1, where assembling the application component migration strategy for each of the selected control application components running on the selected source controller comprises:
extracting the application component migration strategy for each of the selected control application components from a master component migration strategy source.

7. The method of claim 1, wherein extracting the application component migration strategy comprises parsing the master component migration strategy source to include one or more parts of the master component migration strategy source based at least in part on one or more of:
the selected control application component;
the selected source controller; and
the selected target controller.

8. The method of claim 7, wherein the selected control application component running on the selected source controller has a first version, and the selected control application component to be migrated to the selected target controller has a second version that is different from the first version, wherein parsing the master component migration strategy source to include one or more parts of the master component migration strategy source is based at least in part on the first version of the selected control application component running on the selected source controller and the second version of the selected control application component to be migrated to the selected target controller.

9. The method of claim 1, wherein each of the selected one or more of the control application components running on the source controller include one or more control points, the method comprising:
receiving a selection of one or more additional points to add to a selected one of the control application component that are to be migrated to the selected target controller; and
adding the selected one or more additional points to the selected control application component during the migration of the selected control application component from the selected source controller to the selected target controller.

10. The method of claim 1, wherein each of the selected one or more of the control application components running on the source controller include one or more control points, wherein each of the one or more control points are mapped to a corresponding terminal of the source controller, the method comprising:
receiving a mapping of one or more of the control points of a selected one of the control application components to a selected terminal of the target controller.

11. The method of claim 1, wherein the application component migration strategy for each of the selected control application components running on the selected source controller includes a human readable description of one or more steps of the migration of the respective control application component from the selected source controller to the selected target controller.

12. The method of claim 11, wherein the migration plugin identified by the respective application component migration strategy automatically performs one or more of the steps of the migration of the respective control application component from the selected source controller to the selected target controller.

13. The method of claim 12, wherein one or more of the steps that are automatically performed by the migration plugin include one or more of:
migrating one or more configuration settings from the selected source controller to the selected target controller;
migrating support data and/or log information from the selected source controller to the selected target controller;
migrating schedule information from the selected source controller to the selected target controller; and
migrating one or more Fast Access List (FAL) entries from the selected source controller to the selected target controller.

14. The method of claim 1, comprising:
determining one or more components running on the source controller that have an upgrade available; and
providing one or more component upgrade suggestions to a user via a user interface.

15. A migration tool for migrating a source controller to a target controller of a Building Management System (BMS), wherein the source controller runs a control application that includes a plurality of control application components, the migration tool comprising:
an input/output for communicating with the source controller and the target controller;
a user interface;
a controller operatively coupled to the input/output and the user interface, the controller of the migration tool is configured to:
receive a selection via the user interface of the source controller;
receive via the input/output an identification of the plurality of control application components running on the source controller;
receive via the user interface a selection of the target controller;
receive via the user interface a selection of one or more of the control application components running on the source controller to migrate to the selected target controller;
assemble an application component migration strategy for each of the selected control application components running on the selected source controller, wherein the respective application component migration strategy identifies a migration plugin from a plurality of predefined migration plugins of a migration plugin library for migrating the respective control application component from the selected source controller to the selected target controller; and
migrate each of the selected control application components running on the selected source controller from the selected source controller to the selected target controller using the respective migration plugin identified in the respective application component migration strategy.

16. The migration tool of claim 15, wherein one or more of the plurality of control application components is configured by one or more configuration settings, and wherein the controller of the migration tool is configured to:
collect configuration settings associated with each of the control application components running on the source controller via the input/output; and
wherein migrating each of the selected control application components from the selected source controller to the selected target controller using the respective migration plugin identified in the respective application component migration strategy includes migrating the configuration settings associated with the respective control application component.

17. The migration tool of claim 15, wherein one or more of the plurality of control application components collects and stores respective support data and/or log information, and wherein the controller of the migration tool is configured to:
collect support data and/or log information associated with each of the control application components running on the source controller; and
wherein migrating each of the selected control application components from the selected source controller to the selected target controller using the respective migration plugin identified in the respective application component migration strategy includes migrating the support data and/or log information associated with the respective control application component.

18. The migration tool of claim 15, wherein the controller is configured to migrate each of the selected control application components running on the selected source controller from the selected source controller to the selected target controller using the respective migration plugin identified in the respective application component migration strategy without interrupting the operation of the Building Management System (BMS).

19. A non-transitory computer readable medium storing instructions that when executed by one or more processors cause the one or more processors to:
receive a selection via a user interface of a source controller of a Building Management System (BMS);
receive an identification of one or more control application components running on the source controller;
receive a selection of a target controller;
receive a selection of one or more of the control application components running on the source controller to migrate to the selected target controller;
assemble an application component migration strategy for each of the selected control application components running on the selected source controller, wherein the respective application component migration strategy identifies a migration process for migrating the respective control application component from the selected source controller to the selected target controller; and
migrate each of the selected control application components running on the selected source controller from the selected source controller to the selected target controller in compliance with the respective application component migration strategy.

20. The non-transitory computer readable medium of claim 19, wherein the instructions cause the one or more processors to:
collect configuration settings associated with each of the control application components running on the source controller;
migrate the configuration settings associated with the respective control application component from the selected source controller to the selected target controller;
collecting support data and/or log information associated with each of the control application components running on the source controller; and
migrate the support data and/or log information associated with the respective control application component from the selected source controller to the selected target controller.
